(19) United States
(12) Patent Application Publication
(10) Pub. No.: US 2026/0260621 A1
(43) Pub. Date: Sep. 3, 2026

(54) DISPLAY PANEL AND DISPLAY DEVICE

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Chi YU, Beijing (CN); Fan HE, Beijing (CN); Guanghua XU, Beijing (CN); Taofeng XIE, Beijing (CN); Ming HU, Beijing (CN); Wei LIU, Beijing (CN)

(21) Appl. No.: 18/995,743

(22) PCT Filed: Sep. 13, 2023
(86) PCT No.: PCT/CN2023/118642

§ 371 Date: Jan. 16, 2025

(51) Int. Cl. G09G 3/3266; G09G 3/32; G09G 3/3241

(52) U.S. Cl. CPC G09G 3/3266; G09G 3/32; G09G 3/3241; G09G 2300/0413; G09G 2300/0426; G09G 2300/0842; G09G 2300/0861; G09G 2310/0286; G09G 2310/08; G09G 2320/0233; G09G 2330/021; G09G 2330/12

(57) ABSTRACT

The display panel has a display area and a peripheral area outside the display area; the display area is provided with pixel circuits; the peripheral area is provided with a peripheral circuit; at least one peripheral circuit includes a plurality of circuit groups spaced apart along a column direction, a trigger signal line, and at least one test line; one of the circuit groups includes a plurality of shift registers cascaded along the column direction; any row of the pixel circuits is connected to at least one of the shift registers through a scanning line; a first shift register of each circuit group is connected to one trigger signal line, and there are different trigger signal lines connected to different circuit groups; a last shift register of at least one of the circuit groups is connected to one test line.

### TECHNICAL FIELD

The present disclosure relates to the field of display technology, and particularly, to a display panel and a display device.

### BACKGROUND

Display panels using organic light-emitting diodes as light-emitting devices have been widely used in various types of electronic devices, but power consumption of the existing display panels still needs to be improved and the existing display panels are prone to occur abnormalities such as bright lines or dark lines.

It should be noted that the information disclosed in the Background is only used to enhance understanding of the background of the present disclosure, and therefore it may include information that does not constitute existing technology already known to those skilled in the art.

### SUMMARY

The present disclosure provides a display panel and a display device.

According to an aspect of the present disclosure, there is provided a display panel, having a display area and a peripheral area outside the display area. The display area is provided with pixel circuits distributed along a row direction and a column direction; the peripheral area is provided with at least one peripheral circuit distributed along the row direction with the display area; the at least one peripheral circuit includes a plurality of circuit groups spaced apart along the column direction, a trigger signal line, and at least one test line; one of the circuit groups includes a plurality of shift registers cascaded along the column direction; any row of the pixel circuits is connected to at least one of the shift registers through a scanning line;
a first shift register of each circuit group is connected to one trigger signal line, and there are different trigger signal lines connected to different circuit groups; a last shift register of at least one of the circuit groups is connected to one test line; at least a part of any test line is located between the shift register connected thereto and the pixel circuit, and a length of the part of the test line located between the shift register and the pixel circuit in the column direction is smaller than a length of the peripheral circuit in the column direction.

In an exemplary embodiment of the present disclosure, the at least one test line includes a connection segment and a dummy segment discontinuously arranged along an extension trajectory of the test line; the connection segment is connected to the shift register; and the dummy segment is floating.

In an exemplary embodiment of the present disclosure, the test line is located between the shift register connected thereto and the pixel circuit, and at least a partial area extends linearly along the column direction and overlaps with a plurality of scanning lines.

In an exemplary embodiment of the present disclosure, a length of the connection segment is greater than a length of the dummy segment, and a distance between the connection segment and the dummy segment in the column direction is less than the length of the dummy segment.

In an exemplary embodiment of the present disclosure, the at least one test line extends at least partially to a side, away from the pixel circuit, of the shift register connected thereto.

In an exemplary embodiment of the present disclosure, the at least one test line includes a first connection segment, a transition segment, and a second connection segment sequentially connected; the first connection segment is located at a side of the shift register away from the pixel circuit and is connected to the shift register; the transition segment extends along the row direction; and the second connection segment is located at the side of the shift register away from the pixel circuit.

In an exemplary embodiment of the present disclosure, the transition segment of the test line is located between the shift register connected thereto and a first shift register of an adjacent circuit group.

In an exemplary embodiment of the present disclosure, at least a part of the second connection segment extends linearly along the column direction, and a length of the second connection segment is not less than the length of the peripheral circuit in the column direction.

In an exemplary embodiment of the present disclosure, the at least one test line includes a connection segment and a dummy segment discontinuously arranged along an extension trajectory of the test line; the connection segment is connected to the shift register; the dummy segment is floating; and the connection segment includes the first connection segment, the transition segment, and the second connection segment.

In an exemplary embodiment of the present disclosure, a length of the first connection segment is less than a length of the dummy segment.

In an exemplary embodiment of the present disclosure, the second connection segment is located at a side of the trigger signal line away from the pixel circuit.

In an exemplary embodiment of the present disclosure, the peripheral area is further provided with a first power bus, and the first power bus is located at a side of the peripheral circuit away from the display area; the second connection segment is located between the first power bus and the peripheral circuit.

In an exemplary embodiment of the present disclosure, the peripheral area is further provided with a first power bus, and the first power bus is located at a side of the peripheral circuit away from the display area; the transition segment overlaps with the first power bus, and the second connection segment is located at a side of the first power bus away from the peripheral circuit.

In an exemplary embodiment of the present disclosure, the display panel includes a drive backplane and a light-emitting device located at a side of the drive backplane; the peripheral circuit and the pixel circuit are located on the drive backplane;
the transition segment includes a first wire body, an adapter wire body, and a second wire body connected sequentially along the row direction; the first wire body and the second wire body are located in a same layer, and the first power bus is located in a same layer as the first wire body and the second wire body or at a side of the first wire body and the second wire body close to the light-emitting device;
the adapter wire body is located at a side of the first wire body and the second wire body away from the light-emitting device, and overlaps with the first power bus.

In an exemplary embodiment of the present disclosure, the drive backplane includes a substrate and a semiconductor layer, a first gate layer, a second gate layer, a first source-drain layer, and a second source-drain layer arranged sequentially along a direction away from the substrate; the light-emitting device includes a first electrode, a light-emitting layer, and a second electrode stacked sequentially along the direction away from the substrate; the second electrode is connected to the first power bus;
the first power bus, the first wire body, and the second wire body are located in the second source-drain layer; the adapter wire body is located in at least one of the first gate layer, the second gate layer and the first source-drain layer.

In an exemplary embodiment of the present disclosure, the display panel further includes a fan-out area outside the peripheral area; the fan-out area and the display area are distributed along the column direction; both the test line and the trigger signal line extend into the fan-out area;
in the circuit groups of a same peripheral circuit, a test line of a circuit group closest to the fan-out area is located between the shift register connected thereto and the pixel circuit, and at least a partial area extends linearly along the column direction and overlaps with a plurality of scanning lines; a test line of another circuit group extends at least partially to a side, away from the pixel circuit, of the shift register connected thereto.

In an exemplary embodiment of the present disclosure, the fan-out area is provided with a drive chip, and both the trigger signal line and the test line are connected to the drive chip.

In an exemplary embodiment of the present disclosure, the shift register includes an input circuit, a first control circuit, a second control circuit, an output circuit, an output control circuit, and a voltage regulator circuit;
the input circuit is configured to transmit an input signal to a first node in response to a first clock signal; the first control circuit is configured to control a level of a second node in response to a voltage of the first node and the first clock signal; the second control circuit is connected to the first node and the second node, and is configured to control the voltage of the first node under the control of a voltage of the second node and a second clock signal; the voltage regulator circuit is connected to the first node and a third node, and is configured to stabilize a voltage of the third node; the output circuit is connected to the third node, and is configured to output an output signal; the output control circuit is configured to control a voltage of the output signal under the control of the voltage of the second node;
the trigger signal line is connected to the shift register through the input circuit, and the shift register is connected to the test line through the output circuit.

In an exemplary embodiment of the present disclosure, the display panel is divided into a plurality of display portions along the column direction, and one of the display portions includes one circuit group; two adjacent display portions are bendable relative to each other.

According to an aspect of the present disclosure, there is provided a display device, including the display panel according to any one of the above embodiments.

It should be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and together with the description, serve to explain the principles of the present disclosure. Apparently, the drawings in the following description are only for illustrating some embodiments of the present disclosure and those skilled in the art may also derive other drawings based on the drawings without paying any creative labor.

FIG. 1 is a top view of a display panel according to an embodiment of the present disclosure.

FIG. 2 is a partial sectional view of a display panel according to an embodiment of the present disclosure.

FIG. 3 is a schematic view of a pixel circuit of a display panel according to an embodiment of the present disclosure.

FIG. 4 is a schematic view of a shift register a display panel according to an embodiment of the present disclosure.

FIG. 5 is a timing diagram of a shift register a display panel according to an embodiment of the present disclosure.

FIG. 6 is a partial schematic view of a display panel according to a first type of embodiments of the present disclosure.

FIG. 7 is a partial schematic view of a first embodiment of a display panel according to a second type of embodiments of the present disclosure.

FIG. 8 is a partial schematic view of a second embodiment of a display panel according to the second type of embodiments of the present disclosure.

FIG. 9 is a partial schematic view of a third embodiment of a display panel according to the second type of embodiments of the present disclosure.

FIG. 10 is a partial schematic view of a fourth embodiment of a display panel according to the second type of embodiments of the present disclosure.

FIG. 11 is a partial schematic view of a fifth embodiment of a display panel according to the second type of embodiments of the present disclosure.

FIG. 12 is a partial schematic view of an embodiment of a display panel according to the second type of embodiments of the present disclosure.

FIG. 13 is a sectional view of a transition segment and a first power bus of a display panel according to an embodiment of the present disclosure.

FIG. 14 is a partial schematic view of a display panel according to an embodiment of the present disclosure.

### DETAILED DESCRIPTION

Now, the exemplary embodiments will be described more fully with reference to the accompanying drawings. However, the exemplary embodiments may be embodied in a variety of forms and should not be construed as limiting the embodiments set forth herein. Instead, these embodiments are provided so that the present disclosure will be thorough and complete, and the concepts of the exemplary embodiments will be fully given to those skilled in the art. Same reference numerals denote the same or similar structures in the figures, and thus the detailed description thereof will be omitted. In addition, the drawings are merely schematic illustrations of the present disclosure, and are not necessarily drawn to scale.

Words such as “one,” “an/a,” “the” and “said” are used herein to indicate the presence of one or more elements/component parts/and others. Terms “including” and “having” have an inclusive meaning which means that there may be additional elements/component parts/and others in addition to the listed elements/component parts/and others. Terms “first,” “second” and “third” are used herein only as markers, and they do not limit the number of objects modified after them.

A row direction X and a column direction Y herein are two intersecting directions, and may be perpendicular to each other. In the accompanying drawings of the present disclosure, the row direction X is a horizontal direction and the column direction Y is a vertical direction, which are not limited thereto, however. Those skilled in the art may understand that as a display panel is rotated, actual orientations of the row direction X and the column direction Y may change.

A “overlapping with” B herein means that an orthographic projection of A on a substrate at least partially overlaps with an orthographic projection of B on the substrate, and certainly may also mean that orthographic projections of A and B on a plane parallel to the substrate at least partially overlap with each other. A and B “being arranged in a same layer” herein means that A and B belong to different areas of a same continuous or discontinuous film layer.

A transistor herein includes a gate electrode, a first electrode, and a second electrode, and connection and disconnection between the first electrode and the second electrode may be realized by controlling a voltage of the gate electrode. The first electrode may be a source electrode, while the second electrode may be a drain electrode; certainly, the first electrode may also be a drain electrode while the second electrode may be a source electrode. Specifically, if a signal is input from the first electrode, the first electrode is the source electrode while the second electrode is the drain electrode; if the signal is input from the second electrode, the second electrode is the source electrode while the first electrode is the drain electrode. That is, the source electrode and the drain electrode may be interchanged depending on changes of the input signal.

For a P-type transistor, when the gate electrode receives a high level, the first electrode and the second electrode are disconnected; and when the gate electrode receives a low level, the first electrode and the second electrode are connected. For an N-type transistor, when the gate electrode receives a high level, the first electrode and the second electrode are connected; and when the gate electrode receives a low level, the first electrode and the second electrode are disconnected.

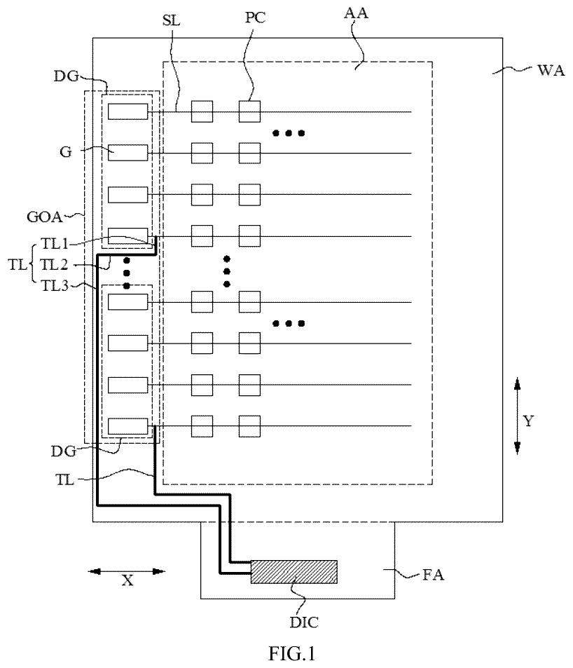

Embodiments of this disclosure provide a display panel. As shown in FIG. 1, the display panel may be divided into a plurality of areas, including a display area AA and a peripheral area WA outside the display area AA. The peripheral area WA may be a continuous annular area surrounding the display area AA or a discontinuous area surrounding outside the display area AA.

In addition, the display panel may also include a fan-out area FA, which may be located at a side of the peripheral area WA away from the display area AA, that is, at an outer side of the peripheral area WA, and which may be connected to the peripheral area WA. The fan-out area FA and the display area AA may be arranged along the column direction Y; for example, the peripheral area WA has a rectangular shape, and the fan-out area FA may be connected to one side edge of the peripheral area WA.

As shown in FIG. 1 and FIG. 2, the display panel may include a drive backplane BP and a plurality of light-emitting devices LD arranged at a side of the drive backplane BP. The light-emitting devices LD may be distributed in an array along the row direction X and the column direction Y and be located in the display area AA. Through a drive circuit in the drive backplane BP, the light-emitting devices LD may be driven to emit light so as to display images.

As shown in FIG. 2, the light-emitting device LD may adopt an OLED (organic light-emitting diode) of an organic light-emitting material; may also adopt a LED (light-emitting diode) of an inorganic light-emitting material, such as Micro LED and Mini LED; and may adopt devices such as QLED (quantum dot diode). The specific structure of the light-emitting device LD is not specifically limited here.

As shown in FIG. 2, the light-emitting device LD using OLED is taken as an example, and may include a first electrode ANO, a light-emitting layer EL, and a second electrode CAT stacked sequentially along a direction away from the drive backplane BP. By applying a first power signal to the first electrode ANO and applying a second power signal to the second electrode CAT, the light-emitting layer EL may be excited to emit light, of which the specific principle will not be described in detail here. Meanwhile, in order to define a range of the light-emitting device LD, a pixel define layer PDL may be provided on the drive backplane BP. The pixel define layer PDL and the first electrode ANO are located on a same surface of the drive backplane BP, and the pixel define layer PDL may have a pixel opening that expose the first electrode ANO, so that the range of the light-emitting device LD may be defined through the pixel opening.

As shown in FIG. 1, the drive circuit may include a pixel circuit PC located in the display area AA and a peripheral circuit GOA located in the peripheral area WA. The pixel circuit PC may be arranged in an array along the row direction X and the column direction Y. One pixel circuit PC may be connected to the first electrode ANO of one light-emitting device LD; and certainly, one pixel circuit PC may also be connected to first electrodes ANO of a plurality of light-emitting devices LD. The pixel circuit PC may include a plurality of transistors and may further include a capacitor, such as 3T1C, 7T1C, etc., in which nTmC indicates that one pixel circuit PC includes n thin film transistors (denoted by letter “T”) and m capacitors (denoted by letter “C”).

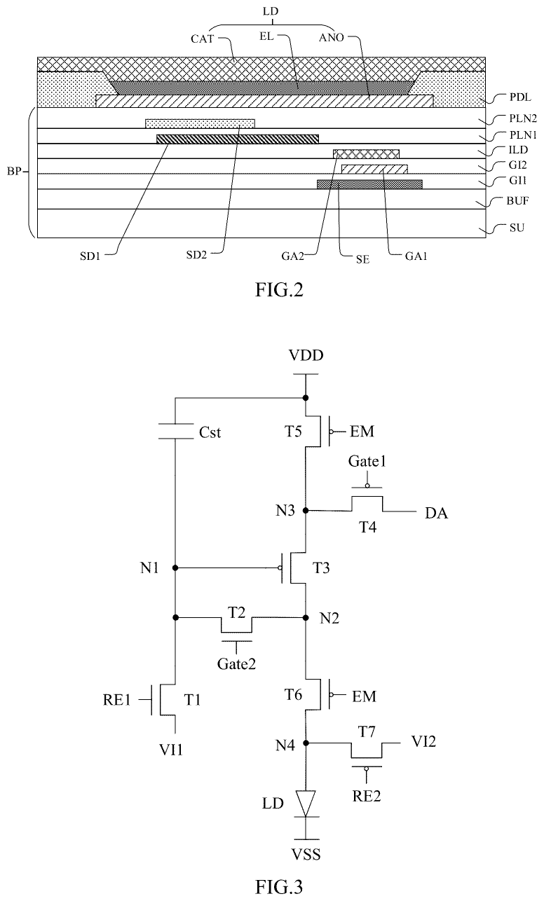

As shown in FIG. 3, the pixel circuit PC with a 7T1C structure is taken as an example, and may include a first reset transistor T1, a compensation transistor T2, a drive transistor T3, a write transistor T4, a first light-emitting control transistor T5, a second light-emitting control transistor T6, a second reset transistor T7, and a storage capacitor Cst. Each transistor may include a gate electrode, a first electrode, and a second electrode, and the first electrode and the second electrode may be connected or disconnected by applying a scanning signal to the gate electrode. The storage capacitor Cst may include a first electrode plate and a second electrode plate that overlap with each other.

As shown in FIG. 3, the gate electrode of the first light-emitting control transistor T5 is used to input a light-emitting scanning signal EM, the first electrode is used to input the first power signal VDD, and the second electrode is connected to the first electrode of the drive transistor T3. The gate electrode of the drive transistor T3 is connected to a first node N1; the second electrode thereof together with the first electrode of the second light-emitting control transistor T6 is connected to a second node N2; the second electrode of the second light-emitting control transistor T6 together with the first electrode ANO of one light-emitting device LD is connected to a fourth node N4; and the gate electrode of the second light-emitting control transistor T6 is used to input the light-emitting scanning signal EM. The second electrode CAT of the light-emitting device LD is used to input the second power signal VSS.

The gate electrode of the first reset transistor T1 is used to input a first reset scanning signal RE1, the first electrode is used to input a first reset signal VI1, and the second electrode is connected to the gate electrode of the drive transistor T3.

The gate electrode of the write transistor T4 is used to input a write scanning signal Gate1, the first electrode thereof is used to input a data signal DA, and the second electrode thereof together with the first electrode of the drive transistor T3 and the second electrode of the first light-emitting control transistor T5 is connected to a third node N3.

The gate electrode of the compensation transistor T2 is used to input a compensation scanning signal Gate2, the first electrode thereof is connected to the second node N2, and the second electrode thereof is connected to the first node N1, so as to be connected to the second electrode and the gate electrode of the drive transistor T3.

The gate electrode of the second reset transistor T7 is used to input a second reset scanning signal RE2, the first electrode thereof is used to input a second reset signal VI2, and the second electrode thereof is connected to the fourth node N4, i.e., connected to the first electrode ANO of the light-emitting device and the second electrode of the drive transistor T3.

The first electrode plate of the storage capacitor Cst is used to input the first power signal VDD, and the second electrode plate thereof is connected to the first node N1, so as to be connected to the gate electrode of the drive transistor T3.

The working principle of the 7T1C pixel circuit will be explained below.

In a first reset stage, the first reset transistor T1 is turned on by the first reset scanning signal RE1, and the first reset signal VI1 is written to the first node N1. The gate electrode of the drive transistor T3 and the second electrode plate of the storage capacitor Cst may be reset.

In a writing stage, the write transistor T4 and the compensation transistor T2 are turned on by writing the scanning signal Gate1 and the compensation scanning signal Gate2, while other transistors are turned off; the data signal DA is written to the first node N1 through the third node N3 and the second node N2 until a potential reaches Vdata+vth, where Vdata is a voltage of the data signal DA and Vth is a threshold voltage of the drive transistor T3. The write scanning signal Gate1 and the compensation scanning signal Gate2 may be a same scanning signal or two synchronized scanning signals.

In a second reset stage, the compensation transistor T2, the write transistor T4, the first light-emitting control transistor T5, and the second light-emitting control transistor T6 are turned off. Meanwhile, the second reset transistor T7 is turned on by the second reset scanning signal RE2, and the second reset signal VI2 is transmitted to the first electrode of the second reset transistor T7 to reset the first electrode ANO of the light-emitting device LD.

In a light-emitting stage, the first light-emitting control transistor T5 and the second light-emitting control transistor T6 are turned on by the light-emitting scanning signal EM, while other transistors are turned off; the drive transistor T3 is turned on under the action of the voltage Vdata+Vth stored in the storage capacitor Cst and the first power signal VDD; the light-emitting device LD emits light under the action of the first power signal VDD and the second power signal VSS. Under the action of the storage capacitor Cst, the drive transistor T3 outputs a current that satisfies the following formula:

$$I = ( μ WCox / 2 L ) {( Vgs - Vth )}^{2}$$

I is an output current of the drive transistor T3; μrepresents carrier mobility; Cox is gate electrode capacitance per unit area; W is a width of a channel of the drive transistor T3; and L is a channel length of the drive transistor T3.

According to the above formula for the output current of the drive transistor T3, the gate voltage Vdata+Vth and a source voltage VDD of the drive transistor T3 in the pixel circuit of the present disclosure may be substituted into the above formula to obtain: I=(μWCox/2L)(Vdata+Vth−VDD−Vth)², where I is the output current of the drive transistor T3. It may be seen that the output current of the pixel circuit is independent of the threshold voltage Vth of the drive transistor T3, but only related to Vdata, thereby eliminating influence of the threshold voltage of the drive transistor T3 on its output current. The control over the output current may be achieved simply through the voltage of the data signal DA, in order to control brightness of the light-emitting device.

The transistors of the 7T1C pixel circuit described above may all use polycrystalline silicon transistors; alternatively, at least part of the transistors may use metal oxide transistors. For example, the first reset transistor T1 and the compensation transistor T2 are metal oxide transistors, while other transistors are polycrystalline silicon transistors. If a metal oxide transistor is used, it is an N-type transistor, and if a polycrystalline silicon transistor is used, it may be a P-type transistor.

The drive backplane BP may also include a data line and a power line extending along the column direction Y. Write transistors of pixel circuits in a same column may be connected to the data line, and the data line is used to transmit the data signal. First light-emitting transistors and storage capacitors of pixel circuits in the same column may be connected to the power line, and the power line is used to transmit the first power signal. Certainly, one data line may also be connected to a plurality of columns of pixel circuits, and one power line may also be connected to a plurality of columns of pixel circuits. Each first power line may be connected to a second power bus (as described below) to receive the first power signal.

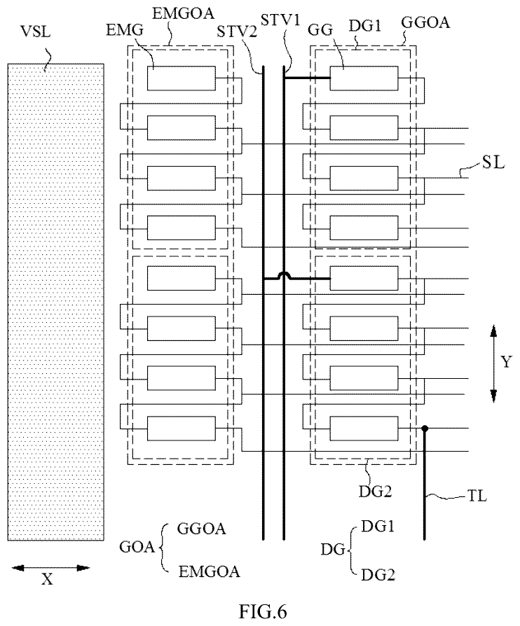

As shown in FIG. 6, the peripheral circuit GOA may be connected to the light-emitting device LD through the pixel circuit PC, and the first power signal is applied to the first electrode ANO of the light-emitting device LD. The peripheral circuit GOA may be a gate drive circuit GGOA, a light-emitting drive circuit EGOA or the like, which is configured to scan the pixel circuit PC. A signal output by the gate drive circuit GGOA and the light-emitting drive circuit EGOA may turn on or off the transistors in the pixel circuit, i.e., scanning the pixel circuit. Taking the 7T1C pixel circuit as an example, the first reset scanning signal RE1, the second reset scanning signal RE2, the write scanning signal Gate1, and the compensation scanning signal Gate2 may be provided by the gate drive circuit GGOA (not limited to one gate drive circuit GGOA), while the light-emitting scanning signal EM may be provided by the light-emitting drive circuit EGOA.

The peripheral circuit GOA may also be connected to the second electrode CAT of the light-emitting device LD and apply the second power signal to the second electrode CAT. The pixel circuit PC may control the current passing through the light-emitting device LD, thereby controlling the brightness of the light-emitting device LD. The peripheral circuit GOA may also include a plurality of cascaded shift registers, i.e., an output signal of a previous shift register serves as an input signal of a next shift register; an input signal of a first shift register may be a trigger signal. In addition, in some embodiments, the first shift register may be a dummy register whose output terminal is not connected to the pixel circuit, but only serves as the input signal for the next shift register.

Any shift register may include a plurality of transistors and capacitors, which may have structures such as 8T2C, 10T3C, etc., and are not specifically limited here. One shift register is taken as an example to illustrate the peripheral circuit GOA.

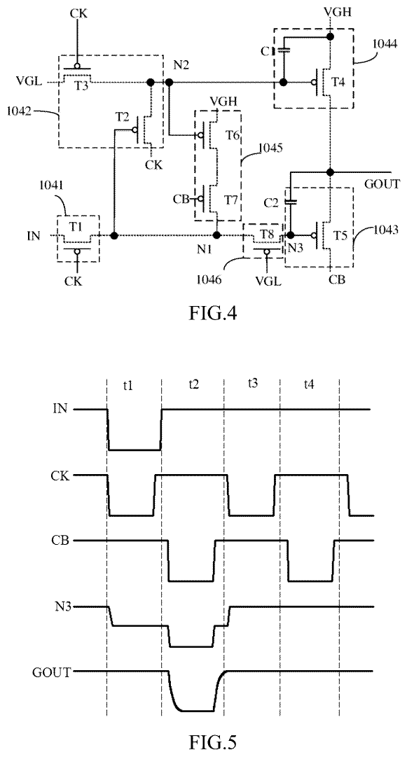

As shown in FIG. 4, in some embodiments of the present disclosure, the shift register includes an input circuit 1041, a first control circuit 1042, a second control circuit 1045, an output circuit 1043, an output control circuit 1044, and a voltage regulator circuit 1046.

The input circuit 1041 is used to transmit the input signal to the first node in response to a first clock signal CK. The first control circuit 1042 is used to control a level of the second node N2 in response to a voltage of the first node N1 and the first clock signal CK. The second control circuit 1045 is connected to the first node N1 and the second node N2, and is used to control the voltage of the first node N1 under the control of a voltage of the second node N2 and a second clock signal CB. The voltage regulator circuit 1046 is connected to the first node N1 and the third node N3, and is used to stabilize a voltage of the third node N3. The output circuit 1043 is connected to the third node N3, and is used to output the output signal. The output control circuit 1044 is used to control a voltage of the output signal under the control of the voltage of the second node.

Further, as shown in FIG. 4, in some embodiments, the shift register includes a plurality of transistors and capacitors, and all transistors are P-type polycrystalline silicon transistors. The input circuit 1041 may include a first transistor T1; the first control circuit 1042 may include a second transistor T2 and a third transistor T3; the output control circuit 1044 may include a fourth transistor T4 and a first capacitor C1; the output circuit 1043 may include a fifth transistor T5 and a second capacitor C2; the second control circuit 1045 may include a sixth transistor T6 and a seventh transistor T7; and the voltage regulator circuit 1046 may include an eighth transistor T8.

A gate electrode of the first transistor T1 is used to receive the first clock signal CK, a first electrode thereof is used to receive the trigger signal or receive the output signal of the cascaded previous shift register, and a second electrode thereof is connected to a gate electrode of the fifth transistor T5 through the eighth transistor T8. Moreover, the second electrode of the first transistor T1 and a first electrode of the eighth transistor T8 are connected to the first node N1, and a second electrode of the eighth transistor T8 and the gate electrode of the fifth transistor T5 are connected to the third node N3. The second capacitor is connected to the third node N3 and a second electrode of the fifth transistor T5.

A gate electrode of the third transistor T3 is used to receive the first clock signal CK, a first electrode thereof is used to receive a first voltage signal, and a second electrode thereof and a gate electrode of the fourth transistor T4 are connected to the second node N2. A gate electrode of the second transistor T2 is connected to the first node N1, a first electrode thereof is used to receive the first clock signal CK, and a second electrode thereof is connected to the second node N2. The first capacitor C1 is connected to the N2 node and a first electrode of the fourth transistor T4. The first electrode of the fourth transistor T4 is used to receive a second voltage, and a second electrode of the fourth transistor T4 and the second electrode of the fifth transistor T5 are connected to an output terminal GOUT to transmit the output signal.

A gate electrode of the sixth transistor T6 is connected to the second node N2, a first electrode thereof is used to receive the second voltage, and a second electrode thereof is connected to a first electrode of the seventh transistor T7. A second electrode of the seventh transistor T7 is connected to the first node N1, and a gate electrode of the seventh transistor T7 is used to receive the second clock signal CB.

The first voltage VGL mentioned above may be a low-level signal, and the second voltage VGH may be a high-level signal.

As shown in FIG. 4 and FIG. 5, the working principle of the 8T2C shift register will be explained below.

In a first stage t1, the first clock signal CK and the trigger signal are at a low level, while the second clock signal CB is at a high level; the first transistor T1 and the third transistor T3 are turned on, while the seventh transistor T7 is turned off; at this time, the input signal is at a low level and written to the first node N1, causing the fifth transistor T5 to turn on and the output terminal GOUT to output the second clock signal CB; meanwhile, the first voltage VGL is written to the second node N2, causing the fourth transistor T4 to turn on and the second voltage VGH to be transmitted to the output terminal GOUT, stabilizing the voltage of the output terminal GOUT at a high level.

In a second stage t2, the first clock signal CK is at a high level while the second clock signal CB is at a low level; the first transistor T1 and the third transistor T3 are turned off, while the seventh transistor T7 is turned on; due to a storage function of the second capacitor C2, the first node N1 may maintain the low level of the previous stage, causing the second transistor T2 and the fifth transistor T5 to turn on; the first clock signal CK is transmitted to the second node N2, and the second node N2 becomes a high level, causing the sixth transistor T6 and the fourth transistor T4 to turn off, avoiding the high-level second voltage VGH from being output to the output terminal GOUT and the first node N1. Meanwhile, since the fifth transistor T5 is turned on, the output signal of the output terminal GOUT is the low-level second clock signal CB, which may be used to turn on at least part of the transistors in the pixel circuit.

In a third stage t3, the first clock signal CK is at a low level, while the second clock signal CB and the trigger signal are at a high level; the first transistor T1 and the third transistor T3 are turned on, while the seventh transistor T7 is turned off; the high-level trigger signal is transmitted to the first node N1 and the third node N3, and the fifth transistor T5 and the second transistor T2 are turned off. The third transistor T3 is turned on, and the low-level first voltage VGL is transmitted to the second node N2 and stored in the first capacitor C1, causing the fourth transistor T4 and the sixth transistor T6 to turn on, at which time the output signal of the output terminal GOUT is the high-level second voltage VGH.

In a fourth stage t4, the first clock signal CK and the trigger signal are at a high level, while the second clock signal CB is at a low level; and the first transistor T1 and the third transistor T3 are turned off, while the seventh transistor T7 is turned on. Due to the storage function of the second capacitor C2, the level of the first node N1 maintain the high level of the previous stage, causing the second transistor T2 and the fifth transistor T5 to turn off. Due to a storage function of the first capacitor C1, the second node N2 continues to maintain the low level of the previous stage, causing the sixth transistor T6 and the fourth transistor T4 to turn on. The second voltage VGH is transmitted to the first node N1 and the third node N3 through the sixth transistor T6 and the seventh transistor T7, so that the first node N1 and the third node N3 continue to maintain the high level, preventing the fifth transistor T5 from turning on, and avoiding erroneous output. The output signal of the output terminal GOUT is the high-level second voltage VGH. FIG. 4 also shows timing of the signal of the node N3.

The structure and principle of the light-emitting drive circuit EGOA of the present disclosure may refer to the gate drive circuit GGOA described above, as long as the first light-emitting control transistor T5 and the second light-emitting control transistor T6 may be scanned, which will not be described in detail here.

It should be noted that reference numerals of the transistors in the gate drive circuit GGOA and reference numerals of the transistors in the pixel circuit are used independently for their respective circuits. The same reference numeral does not represent the same transistor; for example, the first light-emitting control transistor T5 and the fifth transistor T5 are two different transistors belonging to different circuits.

As shown in FIG. 1, in order to facilitate signal transmission, the drive backplane BP may also include a trigger signal line and a scanning line SL. The touch signal line is used to transmit the trigger signal to the first shift register G in the plurality of cascaded shift registers G. An output terminal GOUT of one shift register G may be connected to part of the transistors of a same row of pixel circuits PC through one scanning line SL, and a same shift register G may be connected to a plurality of rows of pixel circuits PC through a plurality of scanning lines SL, which will not be specifically limited herein. Meanwhile, the drive backplane BP may also include a clock signal line and a voltage line connected to the shift register G unit. For example, the clock signal line may include a first clock signal line that transmits the first clock signal CK and a second clock signal line that transmits the second clock signal CB; and the voltage line may include a first voltage line that transmits the first voltage VGL and a second voltage line that transmits the second voltage VGH.

Further, as shown in FIG. 1, in order to input signals to the peripheral circuit GOA and the pixel circuit PC, the display panel may further include a drive chip DIC, which may be arranged in the fan-out area FA. The trigger signal line and the clock signal line (e.g., the first clock signal line and the second clock signal line) may be both connected to the drive chip DIC. The drive chip DIC may be connected to a flexible circuit board through a binding portion of the fan-out area FA, and connected to a control circuit board through the flexible circuit board, so as to control the peripheral circuit GOA under the control of the control circuit board. Certainly, the driver chip DIC may also be arranged on the flexible circuit board, as long as it may be connected to the trigger signal line and the clock signal line.

In some embodiments of the present disclosure, the drive chip DIC is arranged in the fan-out area FA, and the fan-out area FA from the drive backplane BP may be bent towards a side away from the light-emitting device LD, so as to achieve connection with the control circuit board on a backlight side, which helps to reduce a frame.

In some embodiments of the present disclosure, as shown in FIG. 6, there are a plurality of peripheral circuits GOA, including the gate drive circuit GGOA and the light-emitting drive circuit EGOA, which are both connected to the trigger signal line and the clock signal line. However, the trigger signal lines for the gate drive circuit GGOA and the light-emitting drive circuit EGOA are different, and the clock signal lines for them may also be different.

A film layer of the drive backplane BP will be exemplified based on the above drive circuit.

The drive backplane BP may include a substrate SU as well as a semiconductor layer SE, a first gate layer GA1, a second gate layer GA2, a first source-drain layer SD1, and a second source-drain layer SD2 arranged sequentially along a direction away from the substrate SU.

The semiconductor layer SE may be made of materials such as polycrystalline silicon or metal oxides, and an active portion of each transistor is located in the semiconductor layer SE. The specific pattern depends on the specific structure of the circuit and is not specifically limited here.

The first gate layer GA1 is arranged at a side of the semiconductor layer SE away from the substrate SU, overlaps with the semiconductor layer SE, and includes the gate electrode of each transistor. The first gate layer GA1 may also include one electrode plate of each capacitor.

The second gate layer GA2 is arranged at a side of the first gate layer GA1 away from the substrate SU, and may include another electrode plate of each capacitor. Meanwhile, the first gate layer GA1 and the second gate layer GA2 may also be used to form the scanning lines SL or other traces.

The first source-drain layer SD1 is arranged at a side of the second gate layer GA2 away from the substrate SU, and is connected to the semiconductor layer SE through a via hole to achieve connection of at least part of the transistors. The specific pattern depends on the specific structure of the circuit and is not specifically limited here.

The second source-drain layer SD2 is arranged at a side of the first source-drain layer SD1 away from the substrate SU, and may include the data line and the power line mentioned above. The first electrode ANO of the light-emitting device may be connected to the drive transistor through the second source-drain layer SD2. The specific pattern depends on the specific structure of the circuit and is not specifically limited here.

In addition, the drive backplane BP may also include a buffer layer BUF, a first gate insulating layer GI1, a second gate insulating layer GI2, an interlayer dielectric layer ILD, a first planarization layer PLN1, and a second planarization layer PLN2 made of insulating materials. The buffer layer BUF, the first gate insulating layer GI1, the second gate insulating layer GI2, and the interlayer dielectric layer ILD are all made of inorganic materials such as silicon nitride and silicon oxide. The first planarization layer PLN1 and the second planarization layer PLN2 may be both made of resin or other organic materials.

The buffer layer BUF may cover the substrate SU, and the semiconductor layer SE is arranged on a surface of the buffer layer BUF away from the substrate SU. The first gate insulating layer GI1 covers the semiconductor layer SE. The first gate layer GA1 is arranged on a surface of the first gate insulating layer GI1 away from the substrate SU, and the second gate insulating layer GI2 covers the first gate layer GA1. The second gate layer GA2 is arranged on a surface of the second gate insulating layer GI2 away from the substrate SU. The interlayer dielectric layer ILD covers the second gate layer GA2. The first source-drain layer SD1 is arranged on a surface of the interlayer dielectric layer ILD away from the substrate SU. The first planarization layer PLN1 covers the first source-drain layer SD1; alternatively, a passivation layer may be used to cover the first source-drain layer SD1, and then the first planarization layer PLN1 may be used to cover the passivation layer. The second source-drain layer SD2 is arranged on a surface of the first planarization layer PLN1 away from the substrate SU, and the second planarization layer PLN2 covers the second source-drain layer SD2. The first electrode ANO of the light-emitting device is arranged on a surface of the second planarization layer PLN2 away from the substrate SU.

As shown in FIG. 1, in order to reduce power consumption, the peripheral circuit GOA may be controlled through split-screen control. Specifically, the peripheral circuit GOA may be divided into a plurality of circuit groups DG along the column direction Y. The same circuit group DG may include a plurality of cascaded shift registers G, and any shift register G is only cascaded with the shift registers G in the same circuit group DG, and is not connected to shift registers G in other circuit groups DG. Meanwhile, the number of trigger signal lines may be identical to the number of circuit groups DG; a first shift register G of each circuit group DG is connected to one trigger signal line; and different circuit groups DG are connected to different trigger signal lines. Therefore, each circuit group DG and the pixel circuit PC connected thereto may be independently driven; for an area that does not require image display, the corresponding circuit group DG may be turned off, that is, no signal is transmitted to the circuit group DG, thereby reducing the power consumption.

Due to the distribution of the circuit groups DG along the column direction Y, the shift registers G are also cascaded along the column direction Y. Correspondingly, the display area AA may be divided into a plurality of sub-display areas AA distributed along the column direction Y, and each display area AA may be individually turned off. In some embodiments of the present disclosure, the display panel may include a plurality of display portions distributed along the column direction Y; each display portion includes one circuit group DG and the pixel circuit PC and light-emitting device connected thereto; and one display portion includes one sub-display area AA. Meanwhile, the display panel is a bendable display panel, and two adjacent display portions may be bent relative to each other. In such a case, a user may use only one sub-display area AA, so circuit groups DG of display portions where other sub-display areas AA are located may be turned off. The number of circuit group DGs may be two, and correspondingly, the display panel includes two display portions and may be a foldable panel. Certainly, the number of circuit group DGs may also be three or more. In addition, the above scheme is applicable to non-bendable display panels.

Further, in some embodiments, the first shift register of the same circuit group DG may be a dummy register, whose output terminal is not connected to the pixel circuit, but only serves as the input signal for the next shift register. The dummy register may serve to standardize the process and limit the signal transmission time. Certainly, it is also possible that no dummy register is provided, and each shift register G is connected to the pixel circuit PC.

As shown in FIG. 6, the peripheral circuit GOA of the present disclosure may be the gate drive circuit GGOA or the light-emitting drive circuit EGOA, and both may exist simultaneously, that is, there may be a plurality of peripheral circuits GOA. If there are both the gate drive circuit GGOA and the light-emitting drive circuit EGOA, the two may include a plurality of circuit groups DG distributed along the column direction Y, and each circuit group DG is connected to one trigger signal line. Meanwhile, if there are both the gate drive circuit GGOA and the light-emitting drive circuit EGOA, the gate drive circuit GGOA may be located between the light-emitting drive circuit EGOA and the pixel circuit PC, and the scanning line SL connecting the light-emitting drive circuit EGOA and the pixel circuit PC may pass between adjacent shift registers G in the gate drive circuit GGOA. In addition, the peripheral circuit GOA may also include other circuits.

In some embodiments of the present disclosure, the peripheral area of the display panel may also be provided with a first power bus VSL, which may be located on the drive backplane BP and at a side of the peripheral circuit GOA away from the pixel circuit PC, i.e., on an outer side of the peripheral circuit GOA. The first power bus VSL may surround at least part of the display area AA and extend to the fan-out area FA, and the peripheral circuit GOA is located within a range enclosed by the first power bus VSL. The first power bus VSL may be used to transmit the second power signal VSS, and the second electrode CAT of the light-emitting device LD may be connected to the first power bus VSL. The peripheral area may also be provided with a second power bus, which may be located on the drive backplane BP and may be located in the fan-out area FA or in the peripheral area WA between the fan-out area FA and the display area AA, to transmit the first power signal VDD.

In the above scheme, one peripheral circuit GOA is divided into a plurality of circuit groups DG, and the circuit groups DG are not cascaded. During debugging before leaving the factory, it is necessary to test each circuit group DG to check an effect of cascading all shift registers G of the same peripheral circuit GOA when each circuit group DG is in a working state without splitting the screen. For this purpose, the drive backplane BP may include a test line TL, which may be connected to an output terminal of the last shift register G in the circuit group DG, and under the action of the trigger signal, by detecting the output signal output from the output terminal GOUT, it may be determined whether different circuit groups DG may work as a whole or be switched off separately.

As shown in FIG. 1, the inventors have found that since the test line TL is only used for testing and is only connected to the last shift register G of one circuit group DG, and the test line TL may overlap with other traces, parasitic capacitance may be generated; this may cause a load of signal transmission when scanning one or more rows of pixel circuits PC connected to the shift register G connected to the test line TL to be different from a load of signal transmission when scanning other rows of pixel circuits PC, and cause abnormalities such as bright lines, dark lines, or the like to appear in the area corresponding to the pixel circuits PC connected to the shift register G connected to the test line TL, usually at a junction position between two display portions.

In order to solve the above problems, the inventors have designed the test line TL in such a way that the parasitic capacitance caused by the test line TL may be reduced and the load of signal transmission of the shift register G connected thereto may be lowered. Specifically, any test line TL may be located at least partially between the shift register G and the pixel circuit PC connected thereto, and a length of a part of the test line TL located between the shift register G and the pixel circuit PC in the column direction Y is smaller than a length of the peripheral circuit GOA in the column direction Y. The load may be reduced by shortening the length of the test line TL or reducing its parasitic capacitance with other traces.

One peripheral circuit GOA (such as the gate drive circuit GGOA) is taken as an example for illustrative explanation.

### First Type of Embodiments

As shown in FIG. 6, there are a plurality of test lines TL, and the output terminal of the last shift register G of only one circuit group DG is connected to the test line TL. Since other circuit groups DG are not connected to the test lines TL, there is no load caused by the test lines TL. During testing, the signal of the test line TL and the trigger signal of the connected circuit group DG may be used to test the circuit group DG; meanwhile, output signals of other circuit groups DG may be estimated based on the signal of the test line TL to realize the testing. The estimation method may be based on the circuit of the shift register G combined with empirical data, experimental data, etc., or based on a specific algorithm, which will not be specifically limited here.

As shown in FIG. 6, in some embodiments, at least a part of the test line TL may extend along the column direction Y, and may extend to the fan-out area FA and be connected to the drive chip DIC; the signal of the test line TL may be processed through the drive chip DIC. The circuit group DG connected to the test line TL may be the circuit group DG closest to the fan-out area FA among all circuit groups DG, that is, the last circuit group DG, so that the length of the test line TL is shorter, the load generated is smaller, and the test line TL does not overlap with each scanning line SL, which helps to reduce the parasitic capacitance.

Certainly, in other embodiments, the test line TL may be connected to other circuit groups DG, so that if the test line TL extends along the column direction Y by a greater length, it will overlap with part of the scanning lines SL. At this time, the test line TL may extend along the row direction X to the outside of the peripheral circuit GOA, then along the column direction Y, and finally extend to the fan-out area FA, which may reduce the overlap with the scanning line SL and help to reduce the parasitic capacitance.

### Second Type of Embodiments

The number of test lines TL is identical to the number of circuit groups DG, the last shift register G of each circuit group DG is connected to one test line TL, and different circuit groups DG are connected to different test lines TL.

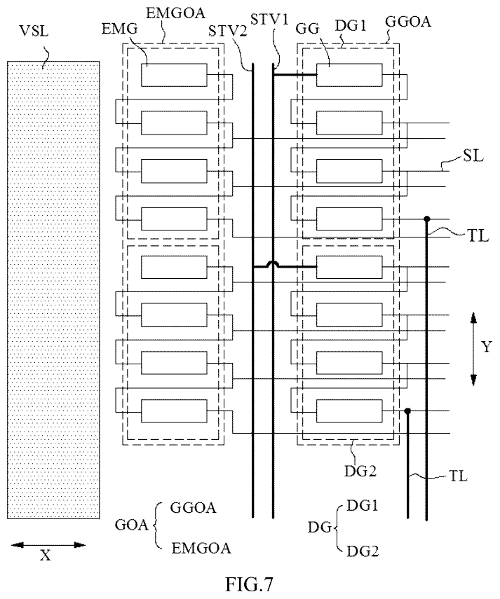

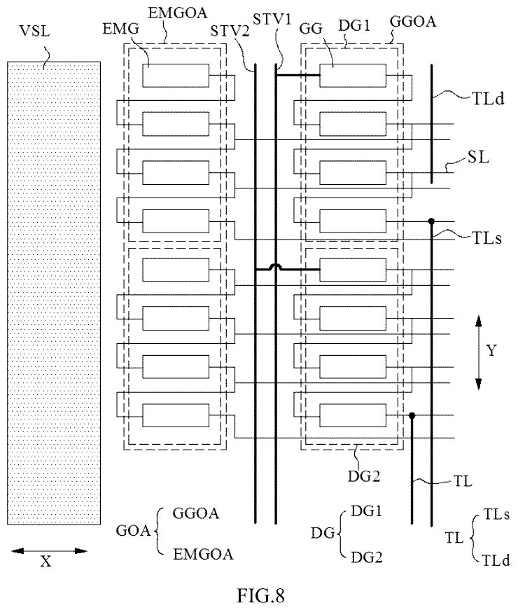

As shown in FIG. 7, in a first embodiment, at least a part of the test line TL extends linearly along the column direction Y and is located between the shift register G and the pixel circuit PC connected thereto. Meanwhile, the part of the test line TL located between the shift register and the pixel circuit PC connected thereto may extend linearly along the column direction Y, and a length of this part in the column direction Y is smaller than the length of the peripheral circuit GOA in the column direction Y, avoiding an excessive length of the test line TL, which may help to reduce the load generated by it. In addition, the test line TL may overlap with a plurality of scanning lines SL, extend into the fan-out area FA, and be connected to the driver chip DIC.

Further, as shown in FIG. 8, in order to improve the uniformity of the process, at least one test line TL may include connection segments TLs and a dummy segment TLd discontinuously arranged along its extension trajectory. The connection segments TLs are connected to the shift register G, while the dummy segment TLd is floating, i.e., receiving no electrical signal.

As shown in FIG. 8, in an example where the peripheral circuit GOA has two circuit groups DG, and two test lines TL and two trigger signal lines are provided, the two circuit groups DG are a first circuit group DG1 and a second circuit group DG2; the two test lines TL are a first test line and a second test line; and the two trigger signal lines are a first trigger signal line STV1 and a second trigger signal line STV2. The second circuit group DG2 is located between the first circuit group DG1 and the fan-out area FA, and is thus closer to the fan-out area FA. The two test lines TL are located between the circuit group DG and the pixel circuit PC; parts of the two test lines TL located between the shift register G and the pixel circuit PC are distributed along the row direction X, and both extend linearly along the column direction Y. The first test line is connected to the last shift register G of the first circuit group DG1, and the first trigger signal line STV1 is connected to the first shift register G of the first circuit group DG1. The second test line is connected to the last shift register G of the second circuit group DG2, and the second trigger signal line STV2 is connected to the first shift register G of the second circuit group DG2. The trigger signal lines are located at a side of the circuit group DG away from the pixel circuit PC and distributed along the row direction X.

The first test line includes the connection segments TLs and the dummy segment TLd. A length of the connection segments TLs is greater than a length of the dummy segment TLd, and a distance between the connection segments TLs and the dummy segment TLd in the column direction Y is less than the length of the dummy segment TLd. The second test line is of an integral structure.

The phrase “between the shift register G and the pixel circuit PC” herein refers to between the shift register G and a column of pixel circuits PC nearest thereto.

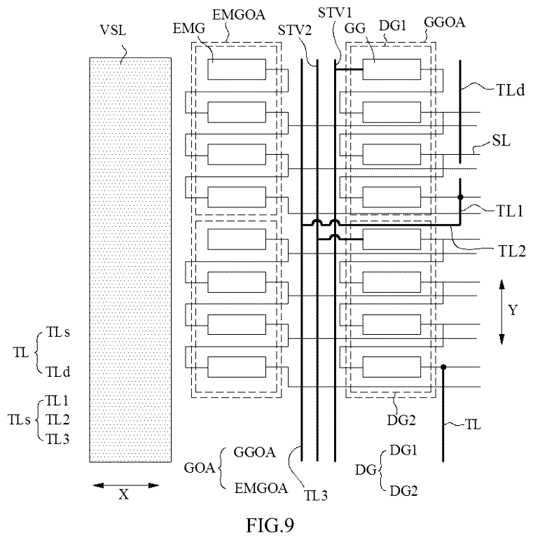

As shown in FIG. 9, in a second embodiment, at least one test line TL extends at least partially to a side of its connected shift register G away from the pixel circuit PC, reducing overlap with the scanning line SL and thus reducing the parasitic capacitance.

The test line TL may include a first connection segment TL1, a transition segment TL2, and a second connection segment TL3 connected sequentially. The first connection segment TL1 is located between the shift register G and the pixel circuit PC, and is connected to the shift register G. The transition segment TL2 may extend along the row direction X. The second connection segment TL3 is located at the side of the shift register G away from the pixel circuit PC. For example, as shown in FIG. 9, the second connection segment TL3 is located at a side of the trigger signal line away from the pixel circuit PC. A bending trajectory connected by the first connection segment TL1, the transition segment TL2, and the second connection segment TL3 enables the test line TL to extend to the side of the shift register G away from the pixel circuit PC, so that at least the transition segment TL2 and the second connection segment TL3 do not overlap with the scanning line SL, the first connection segment TL1 overlaps with at most only a part of the scanning line SL, and if a length of the first connection segment TL1 is less than a distance between adjacent scanning lines SL, the first connection segment may not overlap with the scanning line SL.

For example, as shown in FIG. 9, the peripheral circuit GOA includes the gate drive circuit GGOA and the light-emitting drive circuit EGOA mentioned above. The trigger signal line connected to the gate drive circuit GGOA is located between the gate drive circuit GGOA and the light-emitting drive circuit EGOA, and overlaps with the scanning line SL connected to the light-emitting drive circuit EGOA. The trigger signal line connected to the light-emitting drive circuit EGOA is located at a side of the light-emitting drive circuit EGOA away from the pixel circuit PC. The second connection segment TL3 of the test line TL connected to the gate drive circuit GGOA may be located between the gate drive circuit GGOA and the light-emitting drive circuit EGOA, and at a side, away from the pixel circuit PC, of the trigger signal line connected to the gate drive circuit GGOA. The second connection segment TL3 of the test line TL connected to the light-emitting drive circuit EGOA may be located at the side of the light-emitting drive circuit EGOA away from the pixel circuit PC, and at a side, away from the pixel circuit PC, of the trigger signal line connected to the light-emitting drive circuit EGOA.

Further, the transition segment TL2 of the test line TL may be located between its connected shift register G and the first shift register G of the adjacent circuit group DG, thereby avoiding overlap with the shift register G and the scanning line SL.

Further, as shown in FIG. 9, the second connection segment TL3 may extend linearly along the column direction Y, and a length of the second connection segment TL3 is not less than the length of the peripheral circuit GOA in the column direction Y. Since the second connection segment TL3 is located at the side of the peripheral circuit GOA away from the pixel circuit PC, it will not overlap with the scanning line SL connected to its connected shift register G, so that the length of the second connection segment TL3 may be increased to improve the uniformity of the process. Meanwhile, the transition segment TL2 and the second connection segment TL3 are connected between two ends of the second connection segment TL3, so that the second connection segment TL3 extends along the column direction Y towards both sides of the transition segment TL2.

Further, as shown in FIG. 9, in order to improve the uniformity of the process, the test line TL may include connection segments TLs and dummy segment TLd discontinuously arranged along its extension trajectory. The connection segments TLs are connected to the shift register G, and the dummy segment TLd is floating. The connection segments TLs may include the first connection segment TL1, the transition segment TL2, and the second connection segment TL3 mentioned above, and the specific connection relationship and arrangement will not be repeated here. The dummy segment TLd together with the first connection segment TL1 extends linearly along the column direction Y, and is spaced apart from the first connection segment. An end of the dummy segment TLd away from the fan-out area FA may be aligned with an end of the second connection segment TL3 away from the fan-out area FA in the row direction X. Meanwhile, the length of the first connection segment TL1 is smaller than the length of the dummy segment TLd, and the distance between the dummy segment TLd and the first connection segment TL1 may be smaller than the length of the first connection segment TL1.

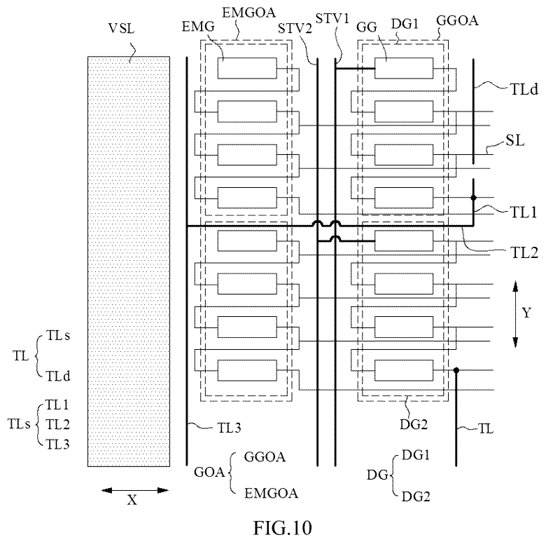

As shown in FIG. 10, in a third embodiment, the first power bus VSL is located at the side of the peripheral circuit GOA away from the pixel circuit PC, and the transition segment TL2 is located at an inner side of the first power bus VSL, i.e., at a side close to the pixel circuit PC. The second connection segment TL3 may be located between the first power bus VSL and the peripheral circuit GOA.

For example, the peripheral circuit GOA includes the gate drive circuit GGOA and the light-emitting drive circuit EGOA mentioned above. The first power bus VSL is located at an outer side of the light-emitting drive circuit EGOA, that is, at the side away from the pixel circuit PC. The test line TL connected to the gate drive circuit GGOA and the second connection segment TL3 of the test line TL connected to the light-emitting drive circuit EGOA may be located between the light-emitting drive circuit EGOA and the first power bus VSL, so that the second connection segment TL3 does not overlap with the scanning line SL, which is beneficial for reducing the parasitic capacitance.

In addition, the test line TL in this embodiment may also include the aforementioned dummy segment TLd, and the relationship between the dummy segment TLd and the first connection segment TL1 may refer to the second embodiment mentioned above, which will not be described in detail here.

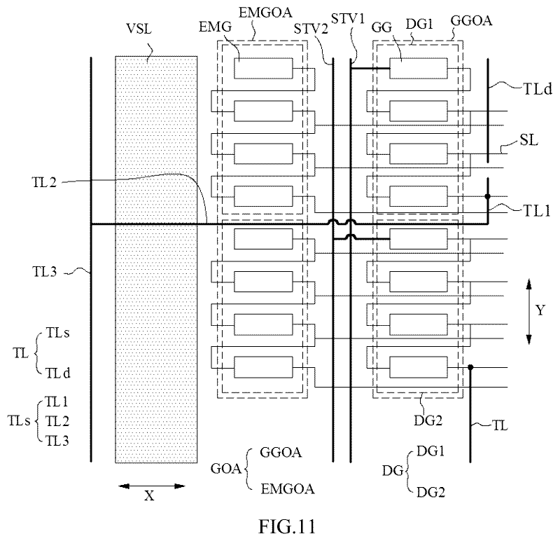

As shown in FIG. 11, in a fourth embodiment, the transition segment TL2 of the test line TL may overlap with the first power bus VSL and extend to an outer side of the first power bus VSL. The second connection segment TL3 is located at a side of the first power bus VSL away from the peripheral circuit GOA, i.e., at the outer side of the first power bus VSL, to avoid the overlap of the second connection segment TL3 with other traces to a greatest extent and reduce the parasitic capacitance.

As shown in FIG. 13, in some embodiments, in order to avoid a short circuit between the transition segment TL2 and the first power bus VSL, a plurality of film layers may be used for jumper wires to make the transition segment TL2 and the first power bus VSL cross in space. For example, the transition segment TL2 may include a first wire body TL21, an adapter wire body TL22, and a second wire body TL23 connected sequentially along the row direction X; the first wire body TL21 and the second wire body TL23 are located in a same layer and are in a different layer from the adapter wire body TL22; for example, the first wire body TL21 and the second wire body TL23 may be located in the second source-drain layer SD2, and the first power bus VSL may be in the same layer as the first wire body TL21 and the second wire body TL23, or may be in the same layer as the first electrode ANO. The adapter wire body TL22 overlaps with the first power bus VSL and is located at a side of the first wire body TL21 and the second wire body TL23 away from the light-emitting device; for example, the adapter wire body TL22 may be in the first gate layer GA1, the second gate layer GA2, or the first source-drain layer SD1. In order to minimize the parasitic capacitance at an overlapping position with the first power bus VSL, a distance between the adapter wire body TL22 and the first power bus VSL may be maximized, in which case the adapter wire body TL22 may be formed using the first gate layer or the second gate layer.

For example, the peripheral circuit GOA includes the gate drive circuit GGOA and the light-emitting drive circuit EGOA mentioned above. The test line TL connected to the gate drive circuit GGOA and the second connection segment TL3 of the test line TL connected to the light-emitting drive circuit EGOA may be located at the outer side of the first power bus VSL, so that the second connection segment TL3 does not overlap with the scanning line SL, which is beneficial for reducing the parasitic capacitance.

It should be noted that in any of the embodiments disclosed herein, there may be overlapping but no electrically connected traces, and the overlap in space may be realized by using a plurality of film layers for jumper wires as described above. That is, the same trace may be divided into a plurality of segments located in different film layers. Only the way in which the transition segment TL2 overlaps with the first power bus VSL is explained above, and other traces with overlapping relationships may also be realized with reference to this scheme. For example, there is an overlapping relationship between the scanning line SL, test line TL, and the trigger signal line in FIGS. 6-12, but they are not actually connected but may overlap through jumper wires.

In some embodiments of the present disclosure, the test lines TL connecting different circuit groups DG in the same peripheral circuit GOA may extend to the fan-out area FA in different ways. For example, for circuit groups DG in the same peripheral circuit GOA, the test line TL of the circuit group DG closest to the fan-out area FA may be located between its connected shift register G and the pixel circuit PC, extend linearly along the column direction Y, and overlap with a plurality of scanning lines SL. The test lines TL of other circuit groups DG may adopt any of the embodiments of the second type mentioned above, i.e., at least partially extending to the side, away from the pixel circuit PC, of the shift register G connected thereto.

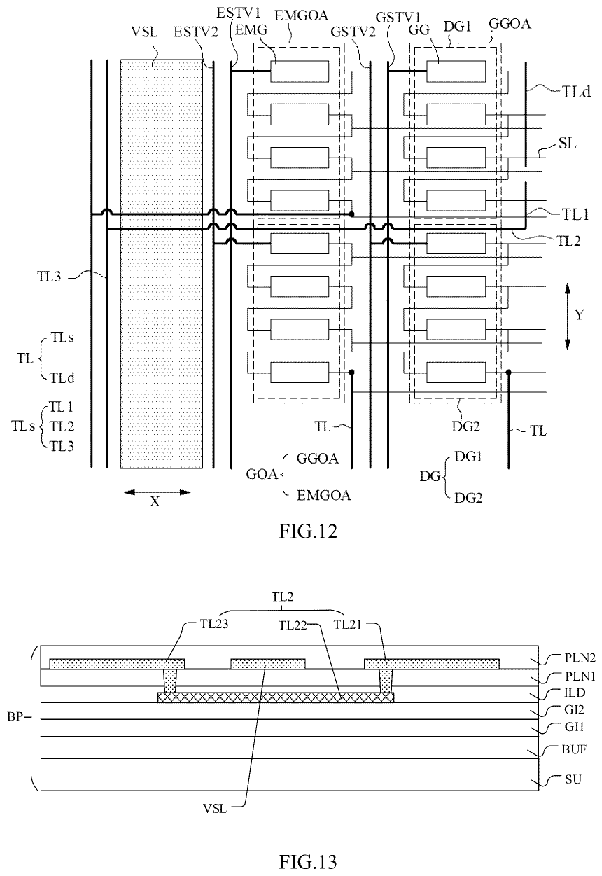

As shown in FIG. 12, in a fifth embodiment, the peripheral circuit GOA includes the gate drive circuit GGOA and the light-emitting drive circuit EGOA mentioned above, and both include two circuit groups DG. The circuit groups of the gate drive circuit GGOA includes a first circuit group DG1 and a second circuit group DG2; its shift register is a gate shift register GG; and the trigger signal lines connected thereto include a first trigger signal line STV1 and a second trigger signal line STV2. The shift register of the light-emitting drive circuit EGOA is a light-emitting shift register EMG, and the trigger signal lines connected thereto include a third trigger signal line ESTV1 and a fourth trigger signal line ESTV2. The circuit groups of the gate drive circuit GGOA and the light-emitting drive circuit EGOA are connected with test lines, and in the same peripheral circuit GOA, the test line TL connected to the circuit group close to the fan-out area FA extends along the column direction Y, while the test line TL connected to the circuit group far away from the fan-out area FA has the second connection segment TL3 located at the outer side of the first power source bus VSL.

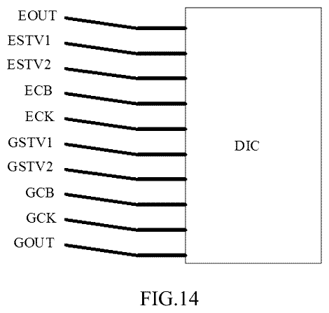

As shown in FIG. 14, FIG. 14 illustrates distribution of wirings between the drive chip DIC and the test line TL, the trigger signal line, and the clock signal line. EOUT is a test line connected to a circuit group of the light-emitting drive circuit EGOA; GOUT is a test line connected to a circuit group of the gate drive circuit GGOA; the first trigger signal line STV1, the second trigger signal line STV2, the third trigger signal line ESTV1, and the fourth trigger signal line ESTV2, as well as the first clock signal line GCK, the second clock signal line GCB, a third clock signal line ECK, and a fourth clock signal line ECB are located between GOUT and EOUT. The third clock signal line ECK and the fourth clock signal line ECB are clock signal lines connected to the light-emitting drive circuit EGOA.

The present disclosure also provides a display device that may include the display panel of any one of the above embodiments. The display panel may be the display panel according to any one of the above embodiments, the specific structure and beneficial effects may refer to the embodiment of the display panel as above mentioned and will not be repeated herein. The display device according to the present disclosure may be a mobile phone, a tablet computer, a television, or other electronic devices with a display function, which will not be enumerated herein.

Other embodiments of the present disclosure will be apparent to those skilled in the art from consideration of the specification and practice of the invention disclosed here. This application is intended to cover any variations, uses, or adaptations of the present disclosure following the general principles thereof and including such departures from the present disclosure as come within known or customary practice in the art. The specification and embodiments are considered to be merely exemplary, and the true scope and spirit of the present disclosure is indicated by the appended claims.

1. A display panel, having a display area and a peripheral area outside the display area, wherein the display area is provided with pixel circuits distributed along a row direction and a column direction; the peripheral area is provided with at least one peripheral circuit distributed along the row direction with the display area; the at least one peripheral circuit comprises a plurality of circuit groups spaced apart along the column direction, a trigger signal line, and at least one test line; one of the circuit groups comprises a plurality of shift registers cascaded along the column direction; any row of the pixel circuits is connected to at least one of the shift registers through a scanning line;
a first shift register of each of the circuit groups is connected to one trigger signal line, and there are different trigger signal lines connected to different circuit groups; a last shift register of at least one of the circuit groups is connected to one test line; at least a part of the test line is located between the shift register and the pixel circuit, and a length of the part of the test line located between the shift register and the pixel circuit in the column direction is smaller than a length of the peripheral circuit in the column direction.

2. The display panel according to claim 1, wherein the at least one test line comprises a connection segment and a dummy segment discontinuously arranged along an extension trajectory of the test line; the connection segment is connected to the shift register; and the dummy segment is floating.

3. The display panel according to claim 2, wherein the test line is located between the shift register and the pixel circuit, and at least a partial area extends linearly along the column direction and overlaps with a plurality of scanning lines.

4. The display panel according to claim 3, wherein a length of the connection segment is greater than a length of the dummy segment, and a distance between the connection segment and the dummy segment in the column direction is less than the length of the dummy segment.

5. The display panel according to claim 1, wherein the at least one test line extends at least partially to a side, away from the pixel circuit, of the shift register connected to the test line.

6. The display panel according to claim 5, wherein the at least one test line comprises a first connection segment, a transition segment, and a second connection segment sequentially connected; the first connection segment is located at a side of the shift register away from the pixel circuit and is connected to the shift register; the transition segment extends along the row direction; and the second connection segment is located at the side of the shift register away from the pixel circuit.

7. The display panel according to claim 6, wherein the transition segment of the test line is located between the shift register and a first shift register of an adjacent circuit group.

8. The display panel according to claim 6, wherein at least a part of the second connection segment extends linearly along the column direction, and a length of the second connection segment is not less than the length of the peripheral circuit in the column direction.

9. The display panel according to claim 6, wherein the at least one test line comprises a connection segment and a dummy segment discontinuously arranged along an extension trajectory of the test line; the connection segment is connected to the shift register; the dummy segment is floating; and the connection segment includes the first connection segment, the transition segment, and the second connection segment.

10. The display panel according to claim 9, wherein a length of the first connection segment is less than a length of the dummy segment.

11. The display panel according to claim 6, wherein the second connection segment is located at a side of the trigger signal line away from the pixel circuit.

12. The display panel according to claim 6, wherein the peripheral area is further provided with a first power bus, and the first power bus is located at a side of the peripheral circuit away from the display area; the second connection segment is located between the first power bus and the peripheral circuit.

13. The display panel according to claim 6, wherein the peripheral area is further provided with a first power bus, and the first power bus is located at a side of the peripheral circuit away from the display area; the transition segment overlaps with the first power bus, and the second connection segment is located at a side of the first power bus away from the peripheral circuit.

14. The display panel according to claim 13, wherein the display panel comprises a drive backplane and a light-emitting device located at a side of the drive backplane; the peripheral circuit and the pixel circuit are located on the drive backplane;
the transition segment includes a first wire body, an adapter wire body, and a second wire body connected sequentially along the row direction; the first wire body and the second wire body are located in a same layer, and the first power bus is located in a same layer as the first wire body and the second wire body or located at a side of the first wire body and the second wire body close to the light-emitting device;
the adapter wire body is located at a side of the first wire body and the second wire body away from the light-emitting device, and overlaps with the first power bus.

15. The display panel according to claim 14, wherein the drive backplane comprises a substrate and a semiconductor layer, a first gate layer, a second gate layer, a first source-drain layer, and a second source-drain layer arranged sequentially along a direction away from the substrate; the light-emitting device comprises a first electrode, a light-emitting layer, and a second electrode stacked sequentially along the direction away from the substrate; the second electrode is connected to the first power bus;
the first power bus, the first wire body, and the second wire body are located in the second source-drain layer; the adapter wire body is located in at least one of the first gate layer, the second gate layer and the first source-drain layer.

16. The display panel according to claim 1, wherein the display panel further comprises a fan-out area outside the peripheral area; the fan-out area and the display area are distributed along the column direction; both the test line and the trigger signal line extend into the fan-out area;
in the circuit groups of a same peripheral circuit, a test line of a circuit group closest to the fan-out area is located between the shift register and the pixel circuit, and at least a partial area extends linearly along the column direction and overlaps with a plurality of scanning lines;
a test line of another circuit group extends at least partially to a side, away from the pixel circuit, of the shift register connected thereto.

17. The display panel according to claim 16, wherein the fan-out area is provided with a drive chip, and both the trigger signal line and the test line are connected to the drive chip.

18. The display panel according to claim 1, wherein the shift register comprises an input circuit, a first control circuit, a second control circuit, an output circuit, an output control circuit, and a voltage regulator circuit;
the input circuit is configured to transmit an input signal to a first node in response to a first clock signal; the first control circuit is configured to control a level of a second node in response to a voltage of the first node and the first clock signal; the second control circuit is connected to the first node and the second node, and is configured to control the voltage of the first node under the control of a voltage of the second node and a second clock signal; the voltage regulator circuit is connected to the first node and a third node, and is configured to stabilize a voltage of the third node; the output circuit is connected to the third node, and is configured to output an output signal; the output control circuit is configured to control a voltage of the output signal under the control of the voltage of the second node;
the trigger signal line is connected to the shift register through the input circuit, and the shift register is connected to the test line through the output circuit.

19. The display panel according to claim 1, wherein the display panel is divided into a plurality of display portions along the column direction, and one of the display portions comprises one circuit group; two adjacent display portions are bendable relative to each other.

20. A display device comprising the display panel according to claim 1.
